(19) United States
(12) Patent Application Publication
(10) Pub. No.: US 2009/0070850 A1
(43) Pub. Date: Mar. 12, 2009

(54) SYSTEM AND METHOD FOR SEARCHING VIDEO SIGNALS

(75) Inventor: Janghwan Lee, Westfield, IN (US)

Correspondence Address: FLETCHER YODER P.C., 7915 FM 1960 RD. WEST, SUITE 330, HOUSTON, TX, 77070, US

(73) Assignee: TTE TECHNOLOGY, INC., Indianapolis, IN (US)

(21) Appl. No.: 12/280,953

(22) PCT Filed: Mar. 15, 2006
(86) PCT No.: PCT/US06/09509

§ 371 Date: Aug. 27, 2008

(51) Int. Cl. G06F 17/30; H04N 7/173

(52) U.S. Cl. 725/131; 707/3

(57) ABSTRACT

There is provided a system and method for searching video signals for content. More specifically, in one embodiment, there is provided a method comprising receiving video programming containing text data and video data, wherein the text data is associated with the video data, extracting the text data from the video programming, determining time information for the extracted text data, and generating an index file containing the extracted text data and the time information for the extracted text data.

### CROSS-REFERENCE TO RELATED APPLICATIONS

This application is a National Phase 371 Application of PCT Application No. PCT/US06/09509, filed Mar. 15, 2006, entitled “SYSTEM AND METHOD FOR SEARCHING VIDEO SIGNALS”.

### FIELD OF THE INVENTION

The present invention relates to the field of processing digital and analog video data. More specifically, the present invention relates to searching video signals for particular content.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Although video transmission was invented over a half century ago, recent advances in video transmission technology are poised to revolutionize the place of video programming, such as television, movies, and so forth, in most people's lives. More specifically, whereas the transmission of video programming was once confined to either analog over-the-air transmissions or analog video tape, modern video programs may be transmitted (or retransmitted) via a variety of transmission sources, such as the Internet, over-the-air digital television signals, and/or digital storage media (e.g., DVDs). This increase in the number of suitable video transmission technologies has facilitated an increase in the number of video programs that the average consumer can access. For example, whereas thirty years ago, the average consumer may have only had access to five television channels, modern consumers may have access to tens, hundreds, or even thousands of different video programming sources from all over the world.

Moreover, advances in data storage technologies have enabled the storage and/or archiving of video programming like never before. For example, digital video recorders (“DVRs”) enable the temporary or permanent storage of video programming for access and/or viewing at a later date. These DVRs are typically able to store hundreds of hours of video programming. Moreover, professional and/or commercial versions of the same technology may be able to store tens of thousands of hours or more.

Although these advances in the transmission and storage of video signals are remarkable, conventional systems still have no efficient way to search stored or incoming video signals for content. In this way, video programming is one of the few information transmission mechanisms that is not currently amendable to computer-assisted searching. For example, if a consumer wished to locate a particular word or phrase in a digitally stored document and/or a webpage, the user need only perform a simple text search of the relevant document or webpage. However, searching a television program, movie, or other video signal for the spoken recitation of the same word or phrase is currently not readily available. Rather, conventional systems enable a user to search for a particular block of video programming (a particular television show, for example), not to search within one or more blocks of video programming for a particular word, phrase, or the like. As such, to find the particular word or phrase, the user has to watch the video programming until the word or phrase is spoken or else jump around within the video signal (e.g., fast forward, rewind, and so forth), until they encounter the desired word or phrase. This type of manual searching is very inefficient. An improved system and method for searching video signals for content is desirable.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system and method for searching video signals for content. More specifically, in one embodiment, there is provided a method comprising receiving video programming containing text data and video data, wherein the text data is associated with the video data, extracting the text data from the video programming, determining time information for the extracted text data, and generating an index file containing the extracted text data and the time information for the extracted text data.

### BRIEF DESCRIPTION OF THE DRAWINGS

Advantages of the invention may become apparent upon reading the following detailed description and upon reference to the drawings in which:

FIG. 1 is a block diagram of a video unit in accordance with an exemplary embodiment of the present invention;

FIG. 2 is a block diagram of a video search system in accordance with an exemplary embodiment of the present invention;

FIG. 3 is a flow chart illustrating a technique generating an index file for a video signal in accordance with an exemplary embodiment of the present invention;

FIG. 4 is a flow chart illustrating a technique for searching an index file of a video signal in accordance with an exemplary embodiment of the present invention; and

FIG. 5 is a graphical representation of a browser page containing an exemplary section of text data and two exemplary still images taken from a video signal in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

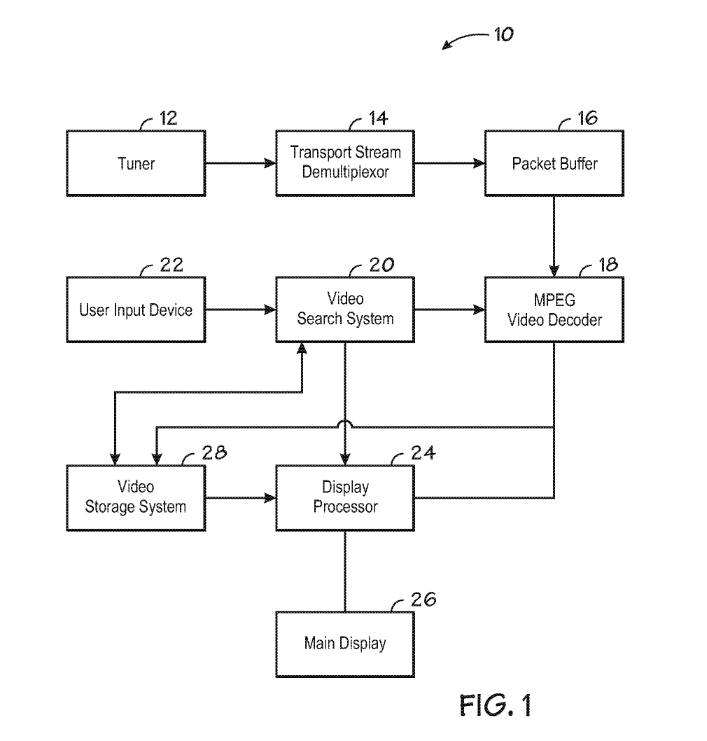

FIG. 1 is a block diagram of an exemplary video unit in accordance with one embodiment of the present invention. This diagram is generally represented by a reference numeral 10. The video unit 10 may include a television set that employs a plasma display, a digital light processing (“DLP”) display, a liquid crystal on silicon (“LCOS”), a projection system, or the like. In various embodiments, the video unit 10 may be adapted to display both analog and digital video signals, including high definition television (“HDTV”) signals.

The video unit 10 may include a tuner 12 which is adapted to receive television signals, such as Advanced Television System Committee (“ATSC”) over-the-air signals or the like. The tuner 12 may be configured to receive a video signal and to generate a video transport stream from the received video signal. For example, in one embodiment, the tuner 12 may be configured to generate an MPEG transport stream. In alternate embodiments, the tuner 12 may be configured to receive and generate other suitable types or forms of video signal including, but not limited to, Quicktime video, MP4 video, and so forth. Moreover, in alternate embodiments of the video unit 10, the tuner 12 may be replaced or operate in conjunction with other suitable video signal sources, such as a DVD player, a digital video recorder (“DVR”), a computer, a wireless receiver, and the like.

As described above, in one embodiment, the tuner 12 may produce a video transport stream that can delivered to a transport stream demultiplexor 14. The transport steam demultiplexor 14 may be configured to separate the video transport stream into video data, audio data, and user data. The video data may include the video programming itself, and the audio data may include the audio that accompanies the video. The user data may include captioning data, subtitle data, and/or other data that supports the video programming.

The transport stream demultiplexor 14 may deliver the video data, the audio data, and the user data to a packet buffer 16. A video decoder 18 may be configured to then read the video data and the user data from the packet buffer 16. In one embodiment, the video decoder 18 may include an MPEG video decoder 18. The video decoder 18 may be configured to decode the video data into video programming and to transmit that video programming to a display processor 24 for potential display on the main display 26.

In addition, the video decoder 18 may be configured to transmit the user data to a video search system 20. The video search system 20 may be configured to perform a variety of functions within the video unit 10. First, the video search system 20 may be configured to process any text accompanying the transmitted video programming. For example, the video search system 20 may be configured to process closed captioning data, teletext data, subtitle data, and/or other suitable forms of accompanying text. In the embodiment illustrated in FIG. 1, this accompanying text may be contained in the user data. In alternate embodiments, however, the video search system 20 may be configured to receive the accompanying text from another suitable source within the video unit 10.

The video search system 20 may also be configured to synchronize this accompanying text to the video programming and to transmit the text, as graphics, to the display processor 24 for display on the main display 26 along with the video programming. Moreover, the video search system 20 may also be configured to generate an index file containing the accompanying text along with time information (e.g. a time stamp) indicative of the portion of the video programming corresponding to each portion of the accompanying text.

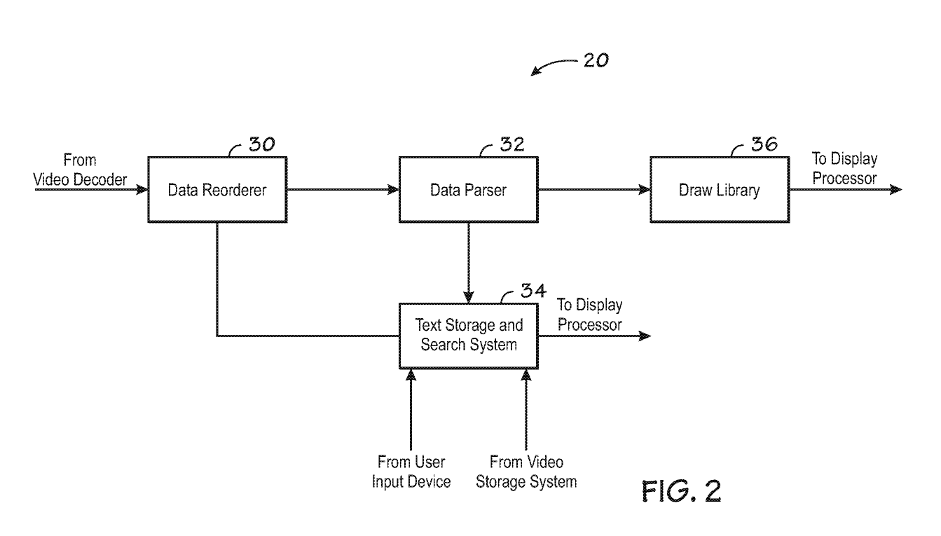

In addition, the video search system 20 may be configured to enable searching of the index file via a user input device 22, such as keyboard, a mouse, a tablet, a network computer system, a remote control, and so forth. Moreover, in one embodiment, as described in greater detail with regard to FIGS. 2-4, the video programming corresponding to successful searches of the index file may be retrieved from a video storage system 28 and displayed (along with the accompanying audio, if appropriate) on the main display. Alternatively, the text surrounding the search terms along with video stills from the corresponding video may displayed as a browser “page” or other suitable graphically representation. In still other embodiments, a combination of these display techniques may be employed in the video unit 10.

As illustrated in FIG. 1, the video decoder 18, the video search system 20, and the video storage system 28 may each be coupled to the display processor 24. The display processor 24 may be configured to condition signals from these sources for display on the main display 26. For example, the display processor may be configured to overlay closed captioning data provided by the video search system 20 onto the video programming provided by the video decoder 18. In addition, the display processor 24 may be configured to display a graphical user interface for searching the index file and/or to display result from searches of the index file.

FIG. 2 is a block diagram of the video search system 20 in accordance with an exemplary embodiment of the present invention. As described above, the video search system 20 may be configured to receive the text data accompanying video programming and to deliver the text to the display processor 24 for display in combination with a video signal. In addition, the video search system 20 may be configured to generate a searchable index of text accompanying the video programming, to perform searches of the index file, and/or to display the results of the searches. In one embodiment, the video search system 20 may include a modified version of standard closed captioning system for digital television or a DVR.

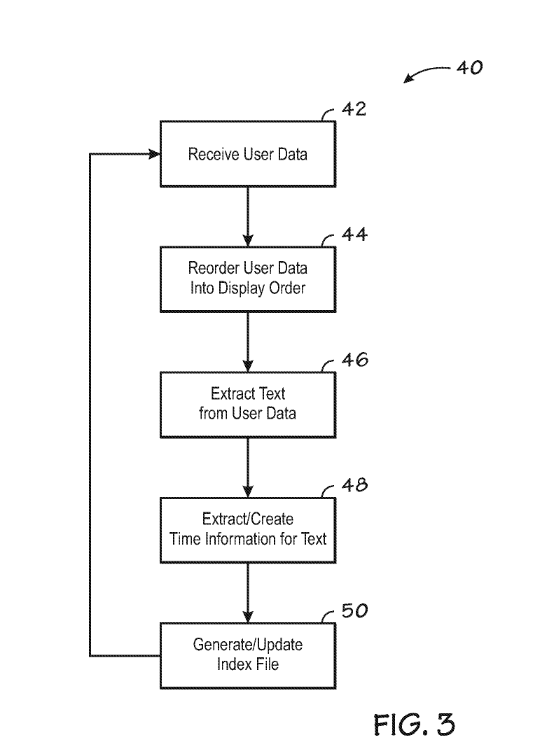

Turning now to the components of the embodiment of the video search system 20 illustrated in FIG. 2. For ease of description, FIG. 2 will be described in conjunction with FIG. 3, a flowchart illustrating an exemplary technique 40 for generating an index file for a video signal. It will be appreciated, however, that in alternate embodiments, the technique 40 may be performed by an suitable type of video unit configured to receive a video signal containing accompanying or embedded text.

As indicated by block 42 of FIG. 3, the technique 40 may begin with user data (e.g., text data) along with picture and/or time information being received by the video search system 20 at a data reorderer 30. In one embodiment, the picture and time information may include information from a sequence decoder, a group of pictures (“GOP”) header, and/or a picture header. As indicated by block 42 of FIG. 3, the data reorderer 30 may be configured to reorder the user data to compensate for any sections of the user data that may be out of order due to errors during transmission of the video signal to the video unit 10, as indicated by block 42. In various embodiments, picture reference codes, picture types, or other suitable attributes may be used by the data reorderer 30 to facilitate this function.

Once the user data has been reordered, the ordered user data (e.g. closed captioning data) may be transmitted to a data parser 32. The data parser 32 may be configured to receive the ordered user data and to extract/process the test data based on the format of the user data, as indicated by block 46. Once extracted and/or processed, the data parser 32 may be transmit the text data to a draw library 36 that will render the text data for display (not shown in FIG. 3). For example, in one embodiment, the text data may include control data that indicates which blocks of text should be displayed together on the main display 26. In such an embodiment, the data parser 32 may be configured to break the text into the properly sized blocks prior to transmission to the draw library 36.

As described above, the data parser 32 is configured to process the user data based on the format of text data. For example, the data parser 32 may be configured to process ATSC 53 data based on the ATSC standard, SCTE 21 data based on the SCTE 21 standard, teletext data based on the teletext standard, embedded text from recorded material (e.g., a DVD) based on the suitable DVD standard, and so forth. In one exemplary embodiment, the data parser 32 may employ an EIA 608 analog-based parser that is embedded in an EIA 708 digital-based data parser.

The data parser 32 may additionally be configured to transmit the text data to text storage and search system 34. The text storage and search system 34 may be configured to receive the text data and to store the text data as entries in an index file. In one exemplary embodiment, the text storage and search system 34 may be configured to receive and store the text data in entries based the text blocks created by the data parser 32. In other words, all of the words that would appear on the screen together for a duration of frames would be stored in one entry in the index file, all of the words that appear on screen at another time would be stored in a second entry in the index file, and so forth. For example, if the phrase “WILL NOW INVESTIGATE” will be displayed first followed by “INAPPROPRAITE CONDUCT AT A” followed by “FACILITY THAT IS SUPPOSED TO,” the first phrase would be stored in the first entry, the second phrase in the second entry, and so forth. Storing the text data in such “screen-sized” entries may advantageously enable the relatively precise identification of the section of video programming that contains the desired content. For example, in one exemplary embodiment, the text storage and search system 34 is configured to limit the length of entry to no more than 20 words.

In another exemplary embodiment, the length of the entries in the index file may be determined based on commands embedded within the accompanying text. For example, the accompanying text may be pre-divided into phrases (e.g., partial closed captioning text sentences) by embedded carriage returns or other control comments between the phrases. In such an embodiment, each entry in the index file may contain the text located between two of the embedded carriage returns. It will be appreciated, however, that in alternate embodiments, text data of other suitable lengths may comprise each of the entries in the index file or that other suitable techniques may be employed to locate the text entries.

As described above, however, the text storage and search system 34 may be configured to create an index file that includes entries containing both the blocks of text data and time information (e.g., a timestamp) corresponding to the time in the video program associated with the text data in that entry. As such, in one embodiment, the data reorderer 30, described above, may also be configured to determine the time information, as indicated in block 48. In one embodiment, the time information includes the length of time since the start of the video programming-in hours, minutes, and seconds followed by a temporal reference number, which is the number of frame counts from the last GOP in the display order. It will be appreciated, however, that in alternate embodiments other suitable formats for the time information may be employed.

The data reordered 30 may be configured to determine the time information from a variety of suitable timing sources. For example, in one exemplary embodiment, the data reorderer 30 may be configured to generate the time information using the system time of the video unit 10. Whereas, in another exemplary embodiment, the data reordered may be configured to extract time information from the user data. For example, the temporal reference number may be extracted from the picture header and a time code may be extracted from the GOP header in the MPEG2 video standard. As those of ordinary skill in the art will appreciate, the time code in a GOP header includes a twenty-five bit field representing hour, minute, second, and picture number. In still another embodiment, the time information may be calculated using the frame rate code from the MPEG2 sequence header.

As described above, once the data reorderer 30 has determined information for the text data for a particular entry, the time information may be transmitted to the text storage and search system 34, where it is matched up with its associated text phrase and used to either create or update the index file, as indicated in block 50. In one exemplary embodiment, the index file generated by the text storage and search system 34 comprises an XML file. For example, the XML corresponding to the exemplary phrases described above, may read as follows:

<? xml version=’1.0’ encoding = ’UTF-8’?>
<clip = ’13-1 News’>
<transcript=’WILL NOW INVESTIGATE’ time=’0:0:0:22’/>
<transcript=’INAPPROPRIATE CONDUCT AT’ time=’0:0:1:19’/>
<transcript=FACILITY THAT IS SUPPOSED TO’ time=’0:0:2:19’/>
</clip>

It will be appreciated, however, that XML is merely one format that may be employed for the index file, and, as such, is not intended to be exclusive.

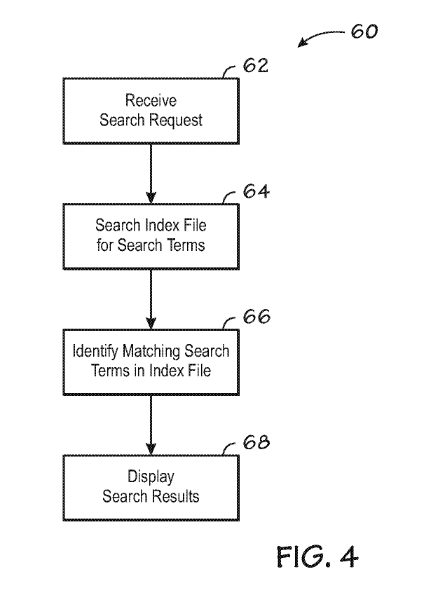

Once generated, the index file may be employed to search the accompanying text for content. This functionality enables a user to search the video programming for content since the accompanying text corresponds to the video programming either directly (closed captioning, teletext, subtitles, and so forth) or indirectly (other types of embedded text). Accordingly, FIG. 4 is a flow chart illustrating an exemplary technique 60 for searching the index file in accordance with one embodiment. The technique 60 may be executed by the text storage and search system 34, by another suitable component of the video unit 10, or by an external unit coupled to the video unit 10.

As indicated by block 62 of FIG. 4, the technique 60 may begin with the text storage and search system 34 receiving a search request. The search terms in the search request may be a single word or a group of words. The search request may be received from the user input device 22 or from another suitable source, such as a computer. The text storage and search system 34 may then search the index file for the word or words in the search request, as indicated by block 64. Any one of a number of suitable search techniques (as know to those of ordinary skill in the art) may be employed to search the index file for the search terms.

Next, the text storage and search system 34 identifies matches for the search terms in the index file, as indicated by block 66. The text storage and search system 34 may then display the search results on the main display 26, as indicated by block 68. If multiple matches are found within the index file, the text storage and search system 34 may list all of the matches on the main display 26 and allow the user to select which match to display on the main display 26, as described below.

A variety of different techniques may be employed by the text storage and search system 34 to display the search results on the main display 26. In one embodiment, the text storage and search system 34 may access the video storage system 28 and instruct the video storage system 28 to display the video programming corresponding to the search results. For example, the text storage and search system 34 may instruct the video storage system to begin displaying video programming at the time contained in the search result, at thirty seconds before, and so forth.

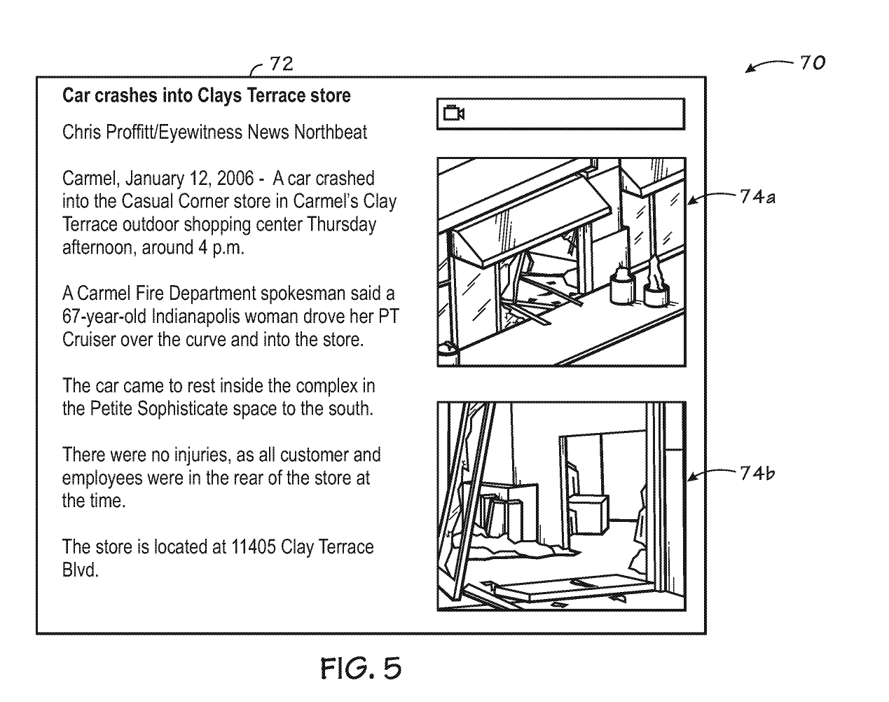

In another exemplary embodiment, the text storage and search system 34 may be configured to retrieve either video programming (or still images) corresponding to the search results from the video storage system 28 and to create a browser “page” containing the video/images and the text associated with the search results (e.g., the text surrounding the search term in the text data). In one exemplary embodiment, the browser page may comprise an XML web page. For example, FIG. 5 is a graphical representation of an exemplary browser page 70 containing an exemplary section of associated text data 72 and two still images 74a, b taken from a video signal in accordance with one embodiment. The browser page 70 may be created by the text storage and search system 34 in response to a search for the search term “car crash.” In still other embodiments, other suitable formats and/or techniques may be employed for displaying the results of the search of the index file.

The video unit 10 facilitates the efficient searching of video programming for content. More specifically, the video unit 10 may enable video programming to be searched as efficiently as any text conventional text document, such as a web page. Advantageously, such searchability may open up video programming to access and cataloging in ways previously reserved for text documents.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method, comprising:
receiving video programming containing text data and video data, wherein the text data is associated with the video data;
extracting the text data from the video programming;
determining time information for the extracted text data; and
generating an index file containing the extracted text data and the time information for the extracted text data.

2. The method of claim 1, comprising:
searching the index file for a search term; and
displaying the video programming associated with the search term.

3. The method of claim 2, wherein displaying the video programming comprises displaying a browser page containing the video programming and the text data surrounding the search term.

4. The method of claim 1, wherein the extracting comprises extracting closed captioning data from the video programming.

5. The method of claim 1, wherein the extracting comprises extracting teletext data from the video programming.

6. The method of claim 1, wherein the extracting comprises extracting subtitle data from the video programming.

7. The method of claim 1, wherein the receiving comprises receiving a digital television signal.

8. The method of claim 1, wherein the receiving comprises receiving video programming from a digital storage medium.

9. The method of claim 1, wherein the determining comprises generating a timestamp based on a time information from a video signal.

10. The method of claim 1, wherein the generating comprises generating the index file in which each entry includes no more than twenty words of text data.

11. A video unit, comprising:
a video search system configured to:
receive video programming containing text data and video data, wherein the text data is associated with the video data;
extract the text data from the video programming;
determine time information for the extracted text data; and
generate an index file containing the extracted text data and the time information for the extracted text data.

12. The video unit of claim 11, wherein the video search system is configured:
to search the index file for a search term; and
to display the video programming associated with the search term.

13. The video unit of claim 12, comprising a video storage system, wherein the video search system is configured to display video programming stored on the video storage system.

14. The video unit of claim 12, comprising a tuner, wherein the video search system is configured to receive video programming from the tuner.

15. The video unit of claim 12, comprising a user input device configured to enter the search term.

16. The video unit of claim 12, wherein the video search system comprises a closed captioning system.

17. A video unit, comprising:
means for receiving video programming containing text data and video data, wherein the text data is associated with the video data;
means for extracting the text data from the video programming;
means for determining time information for the extracted text data; and
means for generating an index file containing the extracted text data and the time information for the extracted text data.

18. The video unit of claim 17, comprising:
means for searching the index file for a search term; and
means for displaying the video programming associated with the search term.

19. The video unit of claim 17, comprising means for displaying a browser page containing the video programming and the text data surrounding the search term.

20. The video unit of claim 17, wherein the means for extracting comprises means for extracting closed captioning data from the video programming.
